(19) United States
(12) Patent Application Publication
(10) Pub. No.: US 2024/0129849 A1
(43) Pub. Date: Apr. 18, 2024

(54) COMMUNICATION SYSTEM, COMMUNICATION CONTROL APPARATUS, COMMUNICATION CONTROL METHOD, AND COMPUTER-READABLE MEDIUM

(71) Applicant: NEC Corporation, Minato-ku, Tokyo (JP)

(72) Inventors: Hiroaki AMINAKA, Tokyo (JP); Kosel KOBAYASHI, Tokyo (JP); Kei YANAGISAWA, Tokyo (JP); Kazuki OGATA, Tokyo (JP); Jun TAKASAWA, Tokyo (JP)

(73) Assignee: NEC Corporation, Minato-ku, Tokyo (JP)

(21) Appl. No.: 18/277,888

(22) PCT Filed: Mar. 31, 2021
(86) PCT No.: PCT/JP2021/013854

§ 371 Date: Aug. 18, 2023

(51) Int. Cl. H04W 52/02; H04W 4/44

(52) U.S. Cl. CPC H04W 52/0203; H04W 4/44

(57) ABSTRACT

The present disclosure makes it possible to effectively reduce power consumption of a roadside wireless communication apparatus. A determination means (21) determines whether a moving body exists on a roadway leading to an intersection. A control means (22) controls a transmission output of a wireless signal being output from a wireless communication apparatus (30), based on a lighting state of a traffic light installed at the intersection and a determination result of the determination means (21).

### TECHNICAL FIELD

The present disclosure relates to a communication system, a communication control apparatus, a communication control method, and a computer-readable medium.

### BACKGROUND ART

As a related art, Patent Literature 1 discloses a mobile communication device mounted on a moving body. The mobile communication device wirelessly communicates with a roadside communication device being a wireless communication apparatus on an infrastructure side. The mobile communication device predicts a future behavior of the moving body on which the mobile communication device is mounted. The mobile communication device predicts a future behavior of the moving body, based on peripheral information transmitted by the roadside communication device and direction information regarding a future advancing direction of the moving body. The mobile communication device adjusts transmission power in the wireless communication, based on a prediction result. For example, in a stop mode in which the moving body is predicted to be in a stop state in future, the mobile communication device lowers the transmission power.

As another related art, Patent Literature 2 discloses a communication control apparatus. The communication control apparatus described in Patent Literature 2 allocates a time zone in which at least one roadside communication device performs wireless transmission, in a time division manner, and opens other time zones for wireless transmission by a mobile communication device. The communication control apparatus acquires light color information related to a light color of a traffic light. The communication control apparatus switches a transmission output of a roadside communication device to the mobile communication device mounted on the moving body moving on a road on which the traffic light gives right of passage, in response to the acquired light color of the traffic light. The communication control device causes the transmission output of the roadside communication device to be lower than a normal level during a period in which the light color of the traffic light is red.

### CITATION LIST

### Patent Literature

[Patent Literature 1] Japanese Unexamined Patent Application Publication No. 2010-219919
[Patent Literature 2] Japanese Unexamined Patent Application Publication No. 2010-170241

### SUMMARY OF INVENTION

### Technical Problem

Patent Literature 1 discloses predicting a future behavior in a moving body and adjusting transmission power of a mobile communication device. However, Patent Literature 1 does not disclose adjusting transmission power of a roadside communication device. Meanwhile, Patent Literature 2 discloses that, when the traffic light indicates a red signal, the transmission output of the roadside communication device is lowered. In this case, it is possible to reduce power consumption of the roadside communication device during a period in which a vehicle is stopped. However, in Patent Literature 2, it is not determined whether a vehicle actually exists on a roadway, and it is not possible to reduce power consumption of the roadside communication device in a period other than the red signal.

In view of the above-described circumstances, an object of the present disclosure is to provide a communication system, a communication control apparatus, a communication control method, and a computer-readable medium that are capable of effectively reducing power consumption of a roadside wireless communication apparatus configured to be capable of wireless communication with a moving body traveling on a road.

### Solution to Problem

In order to achieve the above-described object, the present disclosure provides a communication control apparatus as a first aspect. The communication control apparatus includes a determination means for determining whether a moving body exists on a roadway leading to an intersection, and a control means for controlling a transmission output of a wireless signal being output from a wireless communication apparatus configured to be capable of wireless communication with a moving body traveling at the intersection, based on a lighting state of a traffic light installed at the intersection and a determination result of the determination means.

The present disclosure provides, as a second aspect, a communication system. The communication system includes a wireless communication apparatus configured to be capable of wireless communication with a moving body traveling at an intersection, and a communication control apparatus configured to control the wireless communication apparatus. The communication control apparatus includes a determination means for determining whether a moving body exists on a roadway leading to the intersection, and a control means for controlling a transmission output of a wireless signal being output from the wireless communication apparatus, based on a lighting state of a traffic light installed at the intersection and a determination result of the determination means.

The present disclosure provides, as a third aspect, a communication control method. The communication control method includes: acquiring a lighting state of a traffic light installed at an intersection; determining whether a moving body exists on a roadway leading to the intersection; and controlling a transmission output of a wireless signal being output from a wireless communication apparatus configured to be capable of wireless communication with a moving body traveling at the intersection, based on a lighting state of the traffic light and a result of determining whether a moving body exists on the roadway leading to the intersection.

The present disclosure provides, as a fourth aspect, a computer-readable medium. The computer-readable medium stores a program for causing a processor to perform processing of: acquiring a lighting state of a traffic light installed at an intersection; determining whether a moving body exists on a roadway leading to the intersection; and controlling a transmission output of a wireless signal being output from a wireless communication apparatus configured to be capable of wireless communication with a moving body traveling at the intersection, based on a lighting state of the traffic light and a result of determining whether a moving body exists on a roadway leading to the intersection.

### Advantageous Effects of Invention

The communication system, the communication control apparatus, the communication control method, and the computer-readable medium according to the present disclosure can effectively reduce power consumption of a roadside wireless communication apparatus configured to be capable of wireless communication with a moving body traveling on a road.

### BRIEF DESCRIPTION OF DRAWINGS

FIG. 1 is a block diagram schematically illustrating a communication system according to the present disclosure;

FIG. 2 is a block diagram illustrating a communication system according to an example embodiment of the present disclosure;

FIG. 3 is a block diagram illustrating a configuration example of a communication control apparatus;

FIG. 4 is a schematic diagram illustrating an intersection where a roadside device is arranged;

FIG. 5 is a schematic diagram illustrating a communication range of the roadside device;

FIG. 6 is a schematic diagram illustrating a communication range of the roadside device;

FIG. 7 is a flowchart illustrating an operation procedure in the communication control apparatus;

FIG. 8 is a schematic diagram illustrating a communication range of the roadside device; and

FIG. 9 is a block diagram illustrating a hardware configuration of a communication control apparatus.

### EXAMPLE EMBODIMENT

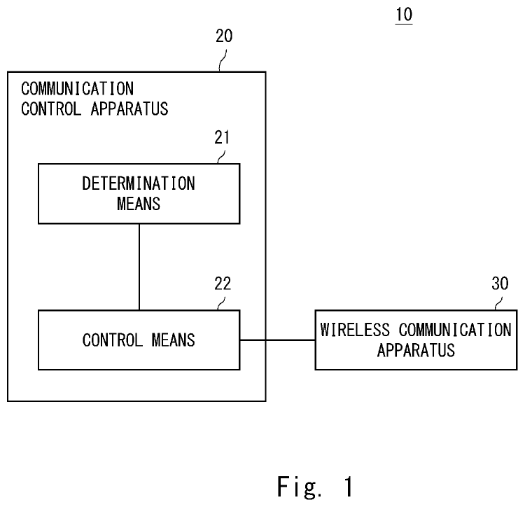

Prior to explanation of the example embodiments of the present disclosure, an outline of the present disclosure will be explained. FIG. 1 schematically illustrates a communication system according to the present disclosure. A communication system 10 includes a communication control apparatus 20 and a wireless communication apparatus 30. The wireless communication apparatus 30 is configured to be capable of wireless communication with a moving body traveling at an intersection. The communication control apparatus 20 controls the wireless communication apparatus 30.

The communication control apparatus 20 includes a determination means 21 and a control means 22. The determination means 21 determines whether a moving body exists on a roadway leading to the intersection. The control means 22 controls a transmission output of a wireless signal being output from the wireless communication apparatus 30, based on a lighting state of a traffic light installed at the intersection and a determination result of the determination means 21.

In the present disclosure, the control means 22 controls the transmission output of the wireless signal being output from the wireless communication apparatus 30 that communicates with the moving body at the intersection, based on the lighting state of the traffic light and the determination result of whether the moving body exists at the intersection. In the present disclosure, the control means 22 can lower the transmission output, for example, when the lighting state indicates that it is impossible to advance or when the determination result indicates that no moving body exists on the roadway. In the present disclosure, the communication control apparatus 20 can reduce the transmission power of the wireless communication apparatus 30 when communication with the moving body is not important, and can effectively reduce power consumption of the wireless communication apparatus 30.

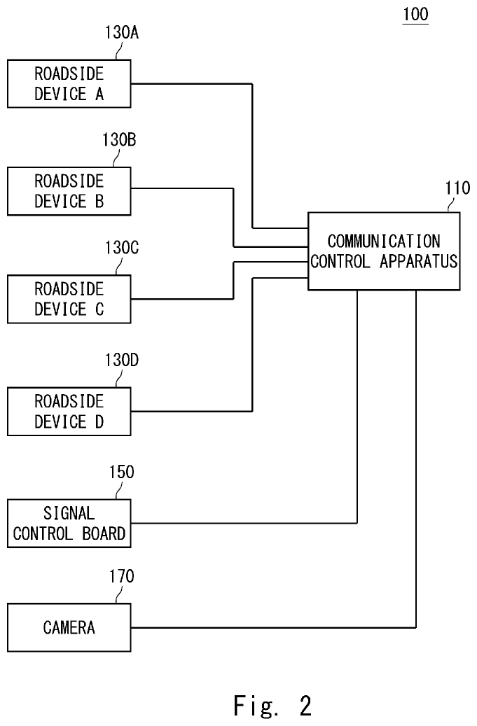

Hereinafter, example embodiments of the present disclosure will be explained in detail. FIG. 2 illustrates a communication system according to an example embodiment of the present disclosure. A communication system 100 includes a communication control apparatus 110, a plurality of roadside devices (roadside devices A to D) 130A to 130D, a signal control board 150, and a camera 170. The communication system 100 is associated to the communication system illustrated in FIG. 1. The communication control apparatus 110 is associated to the communication control apparatus 20 illustrated in FIG. 1. The roadside devices 130A to 130D include wireless communication apparatuses associated to the wireless communication apparatus 30 illustrated in FIG. 1.

It is assumed that a configuration of the communication system 100 at one intersection is illustrated in FIG. 2. At a plurality of intersections, the communication control apparatus 110, the plurality of roadside devices 130, the signal control board 150, and the camera 170 may be installed. The communication control apparatuses 110 installed at a plurality of intersections may operate in cooperation with each other.

The roadside devices (Roadside Unit: RSU) 130A to 130D are installed on a road through which moving bodies pass, such as an intersection. The roadside devices 130A to 130D are installed at one intersection, for example. The roadside devices 130A to 130D are mounted on roadside equipment such as a traffic light. The roadside devices 130A to 130D are configured to be capable of wireless communication with a moving body traveling at an intersection. The moving body includes, for example, land vehicles such as an automobile, a bus, a taxi, and a motorcycle.

In the following description, the roadside devices 130A to 130D are also collectively referred to as roadside devices 130 when no particular distinction is required. Each of the roadside devices 130 performs vehicle-to-roadside-infrastructure communication (V2I communication) with a moving body (in-vehicle communication apparatus). Further, each roadside device 130 can perform wireless communication (Uu communication) with a terminal apparatus possessed by a pedestrian.

The signal control board 150 controls a traffic light at the intersection. The signal control board 150 controls each traffic light installed at the intersection, for example, according to a predetermined signal cycle. The signal control board 150 may be connected to a traffic control center, which is not illustrated, or the like via a network, and may control each traffic light according to an instruction transmitted from the traffic control center.

The camera 170 is an imaging apparatus that photographs a roadway in the vicinity of an intersection. The camera 170 is disposed at an intersection where the roadside device 130 is installed. Note that the number of cameras 170 is not limited to one, and a plurality of cameras 170 may be installed at one intersection.

The communication control apparatus 110 is connected to each roadside device 130, the signal control board 150, and the camera 170. The communication control apparatus 110 controls the roadside device 130 by using information acquired from the signal control board 150 and a video acquired from the camera 170. The communication control apparatus 110 is installed at each intersection, for example. In each intersection, for example, the communication control apparatus 110 controls a group of roadside devices 130 installed at the intersection. The communication control apparatus 110 may be installed at a remote location away from the intersection. In this case, the communication control apparatus 110 may control the roadside device 130 via the network.

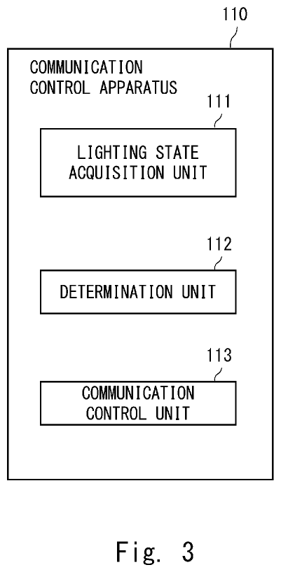

FIG. 3 illustrates a configuration example of the communication control apparatus 110. The communication control apparatus 110 includes a lighting state acquisition unit 111, a determination unit 112, and a communication control unit 113. The communication control apparatus 110 is configured as an apparatus including, for example, a processor and a memory. At least a part of functions of the units in the communication control apparatus 110 can be achieved by a processor executing processing according to a program read from the memory.

The lighting state acquisition unit 111 acquires a lighting state of a traffic light at the intersection where the roadside device 130 is installed. The lighting state acquisition unit 111 acquires the lighting state of the traffic light from, for example, the signal control board 150. The lighting state acquisition unit 111 outputs the acquired lighting state of the traffic light to the communication control unit 113.

The lighting state acquisition unit 111 may perform image analysis on an image photographed by using the camera 170 and acquire the lighting state of the traffic light. For example, the image of the camera 170 may include a video of a traffic light, and the lighting state acquisition unit 111 may determine which color is being lit from the video of the traffic light. The lighting state acquisition unit 111 may acquire the lighting state of the traffic light from the traffic control center or the like via the network.

The determination unit 112 determines whether a moving body exists on the roadway leading to the intersection. In other words, the determination unit 112 detects a moving body existing in the roadway leading to the intersection. For example, the determination unit 112 may determine whether a moving body exists on the roadway by using a video being output from the camera 170 (see FIG. 2). When a moving body exists on the roadway, the determination unit 112 outputs a determination result (detection result) indicating that effect to the communication control unit 113.

The determination unit 112 may further determine whether a pedestrian exists in an area such as a sidewalk through which the pedestrian passes in the vicinity of the intersection by using a video or the like being output from the camera 170. When a pedestrian exists on the sidewalk, the determination unit 112 outputs a determination result indicating that effect to the communication control unit 113. The determination unit 112 is associated to the determination means 21 illustrated in FIG. 1.

The communication control unit 113 controls the transmission output of the wireless signal being output from the roadside device 130, based on the lighting state of the traffic light acquired by the lighting state acquisition unit 111 and the determination result of the determination unit. The communication control unit 113 lowers the transmission output of the wireless signal being output to the roadway, for example, in a case where the lighting state of the traffic light indicates that it is impossible to advance and it is determined that no moving body exists on the roadway, as compared with a case where the light state indicates that it is possible to advance and it is determined that a moving body exists on the roadway. Herein, the lighting state of the traffic light indicating that it is impossible to advance means that, for example, the lighting state of the traffic light is “red” or “yellow”. Alternatively, the lighting state of the traffic light indicating that it is impossible to advance means a state in which the lighting state of the traffic light is “red” or “yellow” and “green light arrow” or “yellow light arrow” is not lit in a certain advancing direction. For example, the communication control unit 113 may change the transmission output of the roadside device 130 by changing at least one of the amplitude and the bandwidth of the wireless signal being output from the roadside device 130. The communication control unit 113 controls, for example, the transmission output of the roadside device 130 to be “high” or “low”.

The communication control unit 113 may change an output direction of the wireless signal being output from the roadside device 130 between a case where it is determined that the moving body exists on a roadway and a case where it is determined that no moving body exists on the roadway. For example, when it is determined that a moving body exists on the roadway, the communication control unit 113 outputs a wireless signal to an area of the roadway on a road leading to the intersection. When it is determined that no moving body exists on the roadway, the communication control unit 113 outputs a wireless signal to a sidewalk on the road leading to the intersection. The communication control unit 113 may stop the transmission output of the wireless signal when it is determined that no moving body exists on the roadway and when it is determined that no pedestrian exists on the sidewalk. The communication control unit 113 is associated to the control means 22 illustrated in FIG. 1.

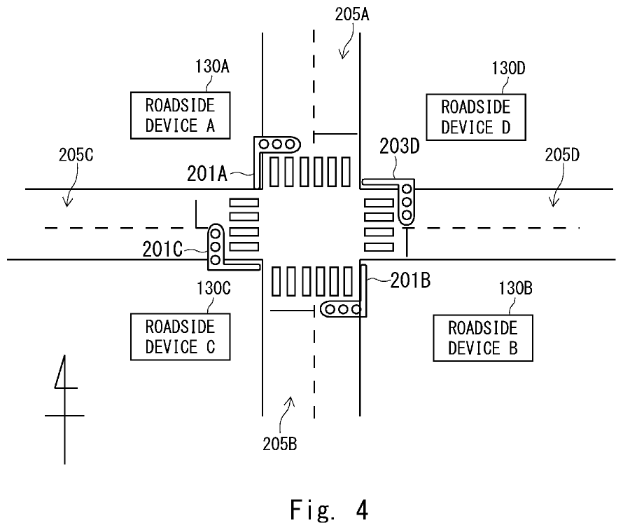

FIG. 4 schematically illustrates an intersection at which the roadside device 130 is arranged. In this example, four traffic lights (traffic lights A to D) 201A to 201D are arranged at the intersection. The traffic lights 201A and 201B, for example, control a passage of the moving body traveling in a north-south direction (first direction). The traffic lights 201C and 201D control, for example, the passage of the moving body traveling in an east-west direction (a second direction). In the following description, the traffic lights 201A to 201D are also collectively referred to as traffic lights 201 when no particular distinction is required. The number of traffic lights 201 installed at one intersection is not limited to four.

The roadside device 130A is disposed in correspondence with the traffic light 201A, and the roadside device 130B is disposed in correspondence with the traffic light 201B. The roadside device 130A and the roadside device 130B are wireless communication apparatuses (first wireless communication apparatuses) configured to be capable of wireless communication with a moving body traveling in the north-south direction at an intersection. The roadside device 130A is configured to be capable of wireless communication with a moving body traveling on a road 205A. The roadside device 130B is configured to be capable of wireless communication with a moving body traveling on a road 205B.

The roadside device 130C is disposed in correspondence with the traffic light 201C, and the roadside device 130D is disposed in correspondence with the traffic light 201D. The roadside device 130C and the roadside device 130D are wireless communication apparatuses (second wireless communication apparatuses) configured to be capable of wireless communication with a moving body traveling in the east-west direction at an intersection. The roadside device 130C is configured to be capable of wireless communication with a moving body traveling on a road 205C. The roadside device 130D is configured to be capable of wireless communication with a moving body traveling on a road 205D. In the following description, the roads 205A to 205D are also collectively referred to as the roads 205 when no particular distinction is necessary.

In FIG. 4, illustration of the camera 170 (see FIG. 2) is omitted. The camera 170 may be installed in each of the traffic lights 201. For example, the camera 170 installed in the traffic light 201A photographs the road 205A. The camera 170 installed in the traffic light 201B photographs the road 205B. The camera 170 installed in the traffic light 201C photographs the road 205C. The camera 170 installed in the traffic light 201D photographs the road 205D.

In the communication control apparatus 110, the lighting state acquisition unit 111 acquires the lighting states of the traffic lights 201A and 201B that control the traffic in the north-south direction and the lighting states of the traffic lights 201C and 201D that control the traffic in the east-west direction. Further, the determination unit 112 determines whether a moving body exists on the roads 205A to 205D, for example, by using a video of the camera 170 installed in each of the traffic lights 201. The communication control unit 113 controls the transmission outputs of the roadside devices 130A to 130D according to which direction is not allowed to advance at the intersection and whether a moving body exists on the roads 205A to 205D.

For example, the communication control unit 113 controls the transmission output of the roadside devices 130A and 130B and the transmission output of the roadside devices 130C and 130D according to whether the lighting state of the traffic light 201 indicates that it is impossible to advance in the north-south direction and whether the lighting state indicates that it is impossible to advance in the east-west direction. The communication control unit 113 controls the transmission outputs of the roadside devices 130A and 130B to be “low” when the lighting states of the traffic lights 201A and 201B each indicate that it is impossible to advance. The communication control unit 113 controls the transmission outputs of the roadside devices 130C and 130D to be “high” when the lighting states of the traffic lights 201C and 201D indicate that it is possible to advance and the moving body exists on at least one of the roads 205C and 205D. In this case, the transmission outputs of the roadside devices 130A and 130B are lower than the transmission outputs of the roadside devices 130C and 130D. The communication control unit 113 controls the transmission outputs of the roadside devices 130C and 130D to be “low” in a case where no moving body exists on any of the roads 205C and 205D even when the lighting states of the traffic lights 201C and 201D indicate that it is possible to advance.

In addition, when the lighting states of the traffic lights 201C and 201D each indicate that it is impossible to advance, the communication control unit 113 controls the transmission outputs of the roadside devices 130C and 130D to be “low”. The communication control unit 113 controls the transmission outputs of the roadside devices 130A and 130B to be “high” when the lighting states of the traffic lights 201A and 201B indicate that the it is possible to advance and the moving body exists on at least one of the roads 205A and 205B. In this case, the transmission outputs of the roadside devices 130C and 130D are lower than the transmission outputs of the roadside devices 130A and 130B. The communication control unit 113 controls the transmission outputs of the roadside devices 130A and 130B to be “low” in a case where no moving body exists on either of the roads 205A and 205B even when the lighting states of the traffic lights 201A and 201A indicate that it is possible to advance.

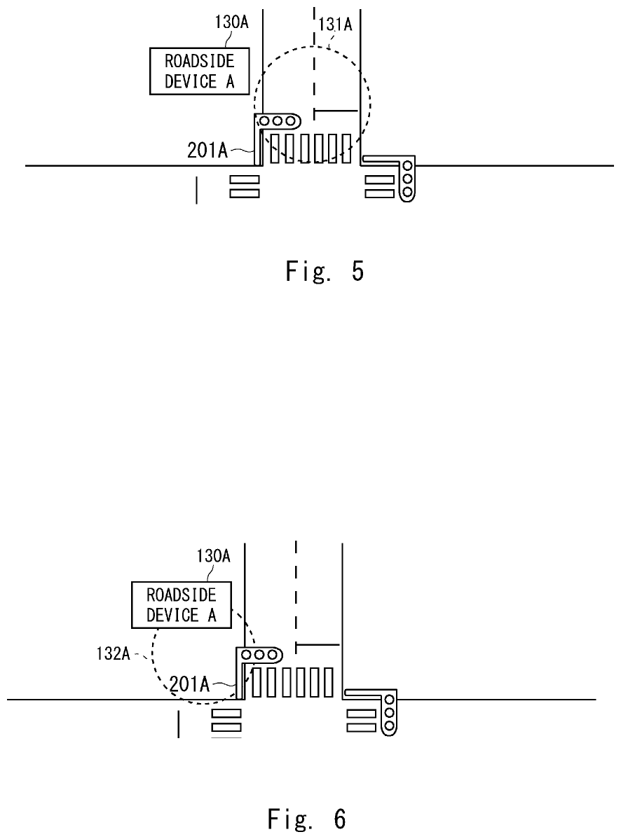

The communication control unit 113 may change a direction (communication range) in which the roadside device 130 outputs a wireless signal according to whether a moving body exists on the road 205. FIGS. 5 and 6 each schematically illustrate a communication range of the roadside device 130A. Herein, a change in the communication range of the roadside device 130 will be explained as an example. The determination unit 112 of the communication control apparatus 110 determines whether a moving body exists on the road 205A. When a moving body exists on the road 205A, the communication control unit 113 controls an output direction of a wireless signal of the roadside device 130A to the road 205A, as illustrated in FIG. 5. In this case, the roadside device 130A can perform wireless communication with the moving body existing in a communication range 131A on the road 205A.

When no moving body exists on the road 205A, the communication control unit 113 controls the output direction of the wireless signal of the roadside device 130A to an area other than the roadway, for example, a sidewalk area, as illustrated in FIG. 6. In this case, the roadside device 130A can perform wireless communication with a mobile terminal possessed by a person such as a pedestrian existing in a communication range 132A including the sidewalk in the vicinity of the traffic light 201A. Similarly, the communication control unit 113 may control the output direction of the wireless signal of the roadside device 130A to the sidewalk area even when the light state of the traffic light 201A indicates that it is impossible to advance.

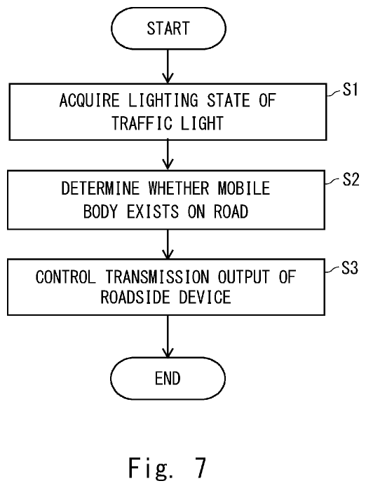

Next, an operation procedure will be explained. FIG. 7 illustrates an operation procedure (communication control method) in the communication control apparatus 110. The lighting state acquisition unit 111 acquires the lighting state of the traffic light 201 (see FIG. 4) (step S1). The determination unit 112 determines whether a moving body exists on the road 205 (step S2). For example, the lighting state acquisition unit 111 acquires the lighting state of the signal for each passing direction of the moving body at the intersection. Further, the determination unit 112 determines whether a moving body exists on the road 205 for each passing direction.

The communication control unit 113 controls the transmission output of the wireless signal being output from the roadside device 130, based on the lighting state of the traffic light 201 acquired in step S1 and the determination result of step S2 (step S3). The communication control unit 113 controls the transmission output of the roadside device 130 to be “high” in a case where, for example, the lighting state indicates that it is possible to advance and it is determined that a moving body exists on the road 205. The communication control unit 113 controls the transmission output of the roadside device 130 to be “low” when, for example, the lighting state indicates that it is impossible to advance or when it is determined that no moving body exists on the road 205.

For example, at an intersection where two passing directions intersect, when a lighting state in a first passing direction indicates that it is possible to advance, a lighting state in a second passing direction indicates that it is impossible to advance. In this case, it is considered that the moving body is stopped on a road in the second passing direction. In some cases, the roadside device 130 does not need to perform wireless communication with the moving body that is being stopped. In the present example embodiment, the communication control unit 113 lowers the transmission output of the roadside device 130 in a direction in which the lighting state of the traffic light indicates that it is impossible to advance. Alternatively, the communication control unit 113 stops wireless transmission of the roadside device 130. By doing so, it is possible to suppress power consumption of the roadside device 130 in a passing direction in which the moving body is stopped.

In the present example embodiment, the communication control unit 113 controls the transmission output of the roadside device 130, based on the determination result of whether a moving body exists on the road in addition to the lighting state of the traffic light 201. When no moving body exists on the road, the roadside device 130 does not have a communication partner, and therefore, it is considered that there is no particular problem even when the transmission output is stopped. In the present example embodiment, when no moving body exists, the power consumption of the roadside device 130 can be suppressed by lowering the transmission output of the roadside device 130 or stopping the wireless transmission.

In the present example embodiment, when no moving body exists or the moving body is stopped, wasteful power consumption of the roadside device 130 can be reduced by lowering the transmission output of the roadside device 130. At the intersection, it is conceivable that the roadside device 130, the signal control board 150, and the camera 170 receive power supply from the same power supply apparatus. In the present example embodiment, since the power consumption of the roadside device 130 can be suppressed, an effect of reducing a power supply capacity of the power supply apparatus installed at the intersection can also be expected.

In the above-described example embodiment, when the lighting state of the traffic light indicates that it is possible to advance in the first passing direction, the communication control unit 113 may control a direction in which the roadside device 130 associated to the first passing direction outputs the wireless signal to the first passing direction. In addition, when the lighting state of the traffic light indicates that it is possible to advance in the second passing direction, the communication control unit 113 may control a direction in which the roadside device 130 associated to the second passing direction outputs the wireless signal to the second passing direction.

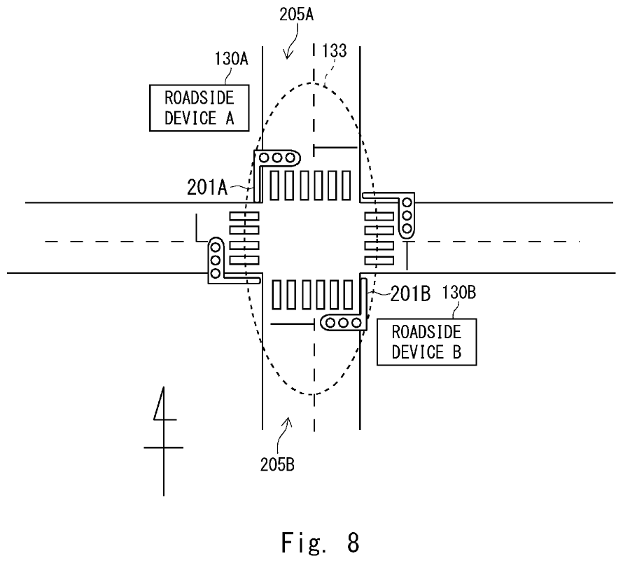

FIG. 8 schematically illustrates a communication range of the roadside devices 130A and 130B. In FIG. 8, it is assumed that the lighting states of the traffic lights 201A and 201B that control the traffic in the north-south direction indicate that it is possible to advance. In this case, the roadside devices 130A and 130B direct the output direction of the wireless signal to a communication range 133 extending in the north-south direction. The communication range 133 extending in the north-south direction may be achieved by using existing beamforming techniques. In this case, the roadside devices 130A and 130B can wirelessly communicate with the moving body in the communication range 133 along a moving direction of the moving body traveling on the roads 205A and 205B.

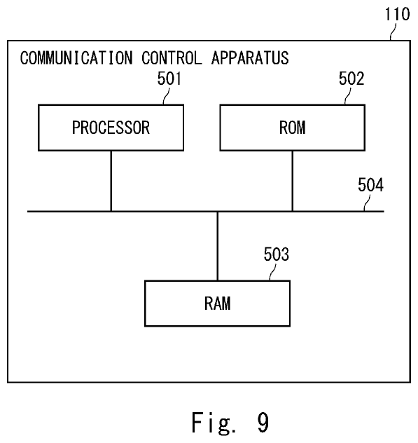

Next, a hardware configuration of the communication control apparatus 110 will be explained. FIG. 9 illustrates a hardware configuration of the communication control apparatus 110. The communication control apparatus 110 includes a processor (CPU: Central Processing Unit) 501, a read only memory (ROM) 502, and a random access memory (RAM) 503. In the communication control apparatus 110, the processor 501, the ROM 502, and the RAM 503 are connected to one another via a bus 504. The communication control apparatus 110 may include other circuits such as a peripheral circuit, a communication circuit, and an interface circuit, although not illustrated.

The ROM 502 is a nonvolatile storage device. For example, a semiconductor storage device such as a flash memory having a relatively small capacity is used as the ROM 502. The ROM 502 stores a program to be executed by the processor 501.

The above-described program may be stored by using various types of non-transitory computer-readable media and supplied to the communication control apparatus 110. Non-transitory computer-readable media include tangible storage media of various types. Examples of the non-transitory computer-readable media include, for example, magnetic recording media, magneto-optical recording media, optical disk media, and semiconductor memory. The magnetic recording medium includes, for example, a medium such as a flexible disk, a magnetic tape, or a hard disk. The magneto-optical recording medium includes, for example, a medium such as a magneto-optical disk. The optical disc media include disc media such as compact discs (CDs) or digital versatile disks (DVDs). The semiconductor memory includes memory such as mask ROM, programmable ROM (PROM), erasable PROM (EPROM), flash ROM, or RAM. The program may also be supplied to the communication control apparatus 110 by using various types of transitory computer-readable media. Examples of the transitory computer-readable media include electrical signals, optical signals, and electromagnetic waves. The transitory computer-readable medium can supply the program to the communication control apparatus 110 via a wired communication path such as an electric wire and an optical fiber, or a wireless communication path.

The RAM 503 is a volatile storage device. Various types of semiconductor memory devices such as Dynamic Random Access Memory (DRAM) or Static Random Access Memory (SRAM) are used as the RAM 503. The RAM 503 may be used as an internal buffer for temporarily storing data and the like.

The processor 501 loads a program stored in the ROM 502 into the RAM 503 and executes the program. When the CPU 501 executes the program, the functions of the units in the communication control apparatus 110 can be achieved.

While the example embodiments of the present disclosure have been explained in detail above, the present disclosure is not limited to the above-described example embodiments, and changes and modifications to the above-described example embodiments without departing from the spirit of the present disclosure are also included in the present disclosure.

For example, some or all of the above-described example embodiments may be described as follows, but are not limited thereto.

### [Supplementary Note 1]

A communication control apparatus including:
determination means for determining whether a moving body exists on a roadway leading to an intersection; and
control means for controlling a transmission output of a wireless signal being output from a wireless communication apparatus configured to be capable of wireless communication with a moving body traveling at the intersection, based on a lighting state of a traffic light installed at the intersection and a determination result of the determination means.

### [Supplementary Note 2]

The communication control apparatus according to supplementary note 1, wherein the control means lowers a transmission output of a wireless signal being output to the roadway in a case where the lighting state indicates that it is impossible to advance, or in a case where the determination result indicates that no moving body exists on the roadway, as compared with a case where the lighting state indicates that it is possible to advance, and the determination result indicates that a moving body exists on the roadway.

### [Supplementary Note 3]

The communication control apparatus according to supplementary note 1 or 2, wherein the control means changes an output direction of the wireless signal between a case where the determination result indicates that a moving body exists on the roadway and a case where the determination result indicates that no moving body exists on the roadway.

### [Supplementary Note 4]

The communication control apparatus according to any one of supplementary notes 1 to 3, wherein the control means outputs a wireless signal to an area of a roadway on a road leading to the intersection when the determination result indicates that a moving body exists on the roadway, and outputs a wireless signal to an area through which a pedestrian passes on a road leading to the intersection when the determination result indicates that no moving body exists on the roadway.

### [Supplementary Note 5]

The communication control apparatus according to supplementary note 4, wherein
the determination means determines whether a pedestrian exists in the area through which the pedestrian passes, and
the control means stops a transmission output of the wireless signal when the determination result indicates that no moving body exists on the roadway and indicates that no pedestrian exists in the area through which the pedestrian passes.

### [Supplementary Note 6]

The communication control apparatus according to any one of supplementary notes 1 to 5, wherein the wireless communication apparatus includes a first wireless communication apparatus configured to be capable of communication with a moving body traveling in a first direction at the intersection, and a second wireless communication apparatus configured to be capable of communication with a moving body traveling in a second direction crossing the first direction at the intersection, and
the control means controls transmission outputs of wireless signals of the first wireless communication apparatus and the second wireless communication apparatus according to whether the lighting state indicates that it is impossible to advance in the first direction and whether the lighting state indicates that it is impossible to advance in the second direction.

### [Supplementary Note 7]

The communication control apparatus according to supplementary note 6, wherein the control means causes a transmission output of a wireless signal of the first wireless communication apparatus to be lower than a transmission output of a wireless signal of the second wireless communication apparatus when the lighting state indicates that it is impossible to advance in the first direction and that it is possible to advance in the second direction, and the determination result indicates that a moving body exists on a roadway in the second direction.

### [Supplementary Note 8]

The communication control apparatus according to supplementary note 6 or 7, wherein the control means further controls a direction in which the first wireless communication apparatus outputs a wireless signal, to be the first direction when the lighting state indicates that it is possible to advance in the first direction, and controls a direction in which the second wireless communication apparatus outputs a wireless signal, to be the second direction when the lighting state indicates that it is possible to advance in the second direction.

### [Supplementary Note 9]

The communication control apparatus according to any one of supplementary notes 1 to 8, wherein the control means changes a transmission output of the wireless signal by changing at least one of an amplitude and a bandwidth of the wireless signal.

### [Supplementary Note 10]

The communication control apparatus according to any one of supplementary notes 1 to 9, wherein the determination means determines whether a moving body exists on the roadway by using a video being output from a photographing apparatus that photographs the roadway.

### [Supplementary Note 11]

A communication system including:
a wireless communication apparatus configured to be capable of wireless communication with a moving body traveling at an intersection; and
a communication control apparatus configured to control the wireless communication apparatus,
wherein the communication control apparatus includes: determination means for determining whether a moving body exists on a roadway leading to the intersection; and
control means for controlling a transmission output of a wireless signal being output from the wireless communication apparatus, based on a lighting state of a traffic light installed at the intersection and a determination result of the determination means.

### [Supplementary Note 12]

The communication system according to supplementary note 11, wherein the control means lowers a transmission output of a wireless signal being output to the roadway in a case where the lighting state indicates that it is impossible to advance, or in a case where the determination result indicates that no moving body exists on the roadway, as compared with a case where the lighting state indicates that it is possible to advance, and the determination result indicates that a moving body exists on the roadway.

### [Supplementary Note 13]

The communication system according to supplementary note 11 or 12, further including a photographing apparatus configured to photograph the roadway, wherein the determination means determines whether a moving body exists on the roadway, by using a video being output from the photographing apparatus.

### [Supplementary Note 14]

A communication control method including:
acquiring a lighting state of a traffic light installed at an intersection;
determining whether a moving body exists in a roadway leading to the intersection; and
controlling a transmission output of a wireless signal being output from a wireless communication apparatus configured to be capable of wireless communication with a moving body traveling at the intersection, based on a lighting state of the traffic light and a result of determining whether a moving body exists on a roadway leading to the intersection.

### [Supplementary Note 15]

A non-transitory computer-readable medium storing a program for causing a processor to perform processing of:
acquiring a lighting state of a traffic light installed at an intersection;
determining whether a moving body exists on a roadway leading to the intersection; and
controlling a transmission output of a wireless signal being output from a wireless communication apparatus configured to be capable of wireless communication with a moving body traveling at the intersection, based on a lighting state of the traffic light and a result of determining whether a moving body exists on a roadway leading to the intersection.

### REFERENCE SIGNS LIST

10 COMMUNICATION SYSTEM
20 COMMUNICATION CONTROL APPARATUS
21 DETERMINATION MEANS
22 CONTROL MEANS
30 WIRELESS COMMUNICATION APPARATUS
100 COMMUNICATION SYSTEM
110 COMMUNICATION CONTROL APPARATUS
111 LIGHTING STATE ACQUISITION UNIT
112 DETERMINATION UNIT
113 COMMUNICATION CONTROL UNIT
130 ROADSIDE DEVICE
150 SIGNAL CONTROL BOARD
170 CAMERA
201 TRAFFIC LIGHT
205 ROAD
501 PROCESSOR
502 ROM
503 RAM
504 BUS

What is claimed is:

1. A communication control apparatus comprising:
a memory storing instructions; and
a processor configured to execute the instructions to:
perform a first determination whether a moving body exists on a roadway leading to an intersection; and
control a transmission output of a wireless signal being output from a wireless communication apparatus configured to be capable of wireless communication with a moving body traveling at the intersection, based on a lighting state of a traffic light installed at the intersection and a result of the first determination.

2. The communication control apparatus according to claim 1, wherein the processor is configured to execute the instructions to lower a transmission output of a wireless signal being output to the roadway in a case where the lighting state indicates that it is impossible to advance, or in a case where the result of the first determination indicates that no moving body exists on the roadway, as compared with a case where the lighting state indicates that it is possible to advance, and the result of the first determination indicates that a moving body exists on the roadway.

3. The communication control apparatus according to claim 1, wherein the processor is configured to execute the instructions to change an output direction of the wireless signal between a case where the result of the first determination indicates that a moving body exists on the roadway and a case where the result of the first determination indicates that no moving body exists on the roadway.

4. The communication control apparatus according to claim 1, wherein the processor is configured to execute the instructions to output a wireless signal to an area of a roadway on a road leading to the intersection when the result of the first determination indicates that a moving body exists on the roadway, and outputs a wireless signal to an area through which a pedestrian passes on a road leading to the intersection when the result of the first determination indicates that no moving body exists on the roadway.

5. The communication control apparatus according to claim 4, wherein
the processor is further configured to execute the instructions to perform a second determination whether a pedestrian exists in the area through which the pedestrian passes, and
stop a transmission output of the wireless signal when the result of the first determination indicates that no moving body exists on the roadway and the result of the second determination indicates that no pedestrian exists in the area through which the pedestrian passes.

6. The communication control apparatus according to claim 1, wherein the wireless communication apparatus includes a first wireless communication apparatus configured to be capable of communication with a moving body traveling in a first direction at the intersection, and a second wireless communication apparatus configured to be capable of communication with a moving body traveling in a second direction crossing the first direction at the intersection, and
the processor is configured to execute the instructions to control transmission outputs of wireless signals of the first wireless communication apparatus and the second wireless communication apparatus according to whether the lighting state indicates that it is impossible to advance in the first direction and whether the lighting state indicates that it is impossible to advance in the second direction.

7. The communication control apparatus according to claim 6, wherein the processor is configured to execute the instructions to cause a transmission output of a wireless signal of the first wireless communication apparatus to be lower than a transmission output of a wireless signal of the second wireless communication apparatus when the lighting state indicates that it is impossible to advance in the first direction and that it is possible to advance in the second direction, and the result of the first determination indicates that a moving body exists on a roadway in the second direction.

8. The communication control apparatus according to claim 6, wherein the processor is further configured to execute the instructions to control a direction in which the first wireless communication apparatus outputs a wireless signal, to be the first direction when the lighting state indicates that it is possible to advance in the first direction, and control a direction in which the second wireless communication apparatus outputs a wireless signal, to be the second direction when the lighting state indicates that it is possible to advance in the second direction.

9. The communication control apparatus according to claim 1, wherein the processor is configured to execute the instructions to change a transmission output of the wireless signal by changing at least one of an amplitude and a bandwidth of the wireless signal.

10. The communication control apparatus according to claim 1, wherein the processor is configured to execute the instructions to perform the first determination by using a video being output from a photographing apparatus that photographs the roadway.

11. A communication system comprising:
a wireless communication apparatus configured to be capable of wireless communication with a moving body traveling at an intersection; and
the communication control apparatus according to claim 1.

12. The communication system according to claim 11, wherein the processor is configured to execute the instructions to lower a transmission output of a wireless signal being output to the roadway in a case where the lighting state indicates that it is impossible to advance, or in a case where the result of the first determination indicates that no moving body exists on the roadway, as compared with a case where the lighting state indicates that it is possible to advance, and the result of the first determination indicates that a moving body exists on the roadway.

13. The communication system according to claim 11, further comprising a photographing apparatus configured to photograph the roadway,
wherein the processor is configured to execute the instructions to perform the first determination by using a video being output from the photographing apparatus.

14. A communication control method comprising:
acquiring a lighting state of a traffic light installed at an intersection;
determining whether a moving body exists in a roadway leading to the intersection; and
controlling a transmission output of a wireless signal being output from a wireless communication apparatus configured to be capable of wireless communication with a moving body traveling at the intersection, based on a lighting state of the traffic light and a result of determining whether a moving body exists on a roadway leading to the intersection.

15. A non-transitory computer-readable medium storing a program for causing a processor to perform processing of:
acquiring a lighting state of a traffic light installed at an intersection;
determining whether a moving body exists on a roadway leading to the intersection; and
controlling a transmission output of a wireless signal being output from a wireless communication apparatus configured to be capable of wireless communication with a moving body traveling at the intersection, based on a lighting state of the traffic light and a result of determining whether a moving body exists on a roadway leading to the intersection.
